(19) United States
(12) Patent Application Publication
(10) Pub. No.: US 2021/0097754 A1
(43) Pub. Date: Apr. 1, 2021

(54) VIRTUAL DISPLAY MONITORS

(71) Applicant: Hewlett-Packard Development Company, L.P., Spring, TX (US)

(72) Inventors: Mithra Vankipuram, Palo Alto, CA (US); Ian N. Robinson, Palo Alto, CA (US)

(73) Assignee: Hewlett-Packard Development Company, L.P., Spring, TX (US)

(21) Appl. No.: 17/045,778

(22) PCT Filed: Jun. 22, 2018
(86) PCT No.: PCT/US2018/039004

§ 371 Date: Oct. 7, 2020

(51) Int. Cl. G06T 15/20; H04N 5/225; G06F 3/01; H04N 13/332; G06T 7/70

(52) U.S. Cl. CPC G06T 15/20; H04N 5/2257; G06T 7/70; G06F 3/017; H04N 13/332; H04N 5/2253

(57) ABSTRACT

An example system includes a camera to capture an image of a physical tag, a virtual environment display portion to generate a virtualized environment, a virtual display monitor forming portion to create a virtual display monitor in the virtualized environment, and a headset including a head-mounted display to display the virtualized environment, the virtualized environment including the virtual display monitor. A position of the virtual display monitor in the virtualized environment corresponds to a physical location of the physical tag. At least one parameter of the virtual display monitor is associated with the physical tag.

### BACKGROUND

Most work environments include a computer system. Such computer systems may take the form of desktop computer or laptop computers. A typical computer system includes input devices, such as a keyboard and a mouse, and a display device. For desktops, the display device may be a dedicated monitor positioned on a desk surface. For laptops, the display device is included in the laptop, with additional monitors that may be connected to the laptop.

### BRIEF DESCRIPTION OF THE DRAWINGS

For a more complete understanding of various examples, reference is now made to the following description taken in connection with the accompanying drawings in which:

FIG. 1 illustrates an example virtualization system;

FIGS. 2A and 2B illustrate an example physical environment with a physical tag and a corresponding example virtual display monitor;

FIG. 3 illustrates an example arrangement with a user having a virtualization headset;

FIG. 4 is a flow chart illustrating an example method for forming a virtual display monitor in a virtualized environment; and

FIG. 5 illustrates a block diagram of an example system with a computer-readable storage medium including instructions executable by a processor for forming a virtual display monitor.

### DETAILED DESCRIPTION

As noted above, computer systems typically include input devices and display devices. Display devices, such as monitors, can be bulky and use a large amount of desk space. Further, monitors can be costly. These factors can limit the number of monitors that a user may have in a workspace. Further, addition of monitors to a computer system can be a cumbersome process.

Various examples described herein relate to virtual display monitors. In various examples, a virtualization headset includes a display and a processor. Virtualization headsets may present a virtualized environment to a user. As used herein, a virtualized environment may include a virtual reality (VR) environment or an augmented reality (AR) environment. The processor can cause the display to present the virtualized environment to a user. A user may place a physical tag within view of a camera coupled to the headset. The tag may be a printed identifier, such as a two-dimensional bar code, for example. The processor may associate the physical tag with parameters related to a virtual display monitor. The parameters may include dimensions, resolution, positioning, or other such characteristics of a monitor, for example. The physical tag may be printed by the user using, for example, a printer coupled to the headset (e.g., HP Sprocket). The processor may then generate the virtual display monitor and display it within the virtualized environment displayed in the headset. The location of the virtual display monitor in the virtualized environment may be associated with the physical location of the physical tag. Thus, a user may place a physical tag in any location where a virtual display monitor may be desired, such as adjacent to an existing physical monitor. In this regard, a user with a virtualization system may add monitors without the need to purchase costly, space-consuming physical monitors. The virtual display monitor may be used to extend the display on a physical monitor, for example.

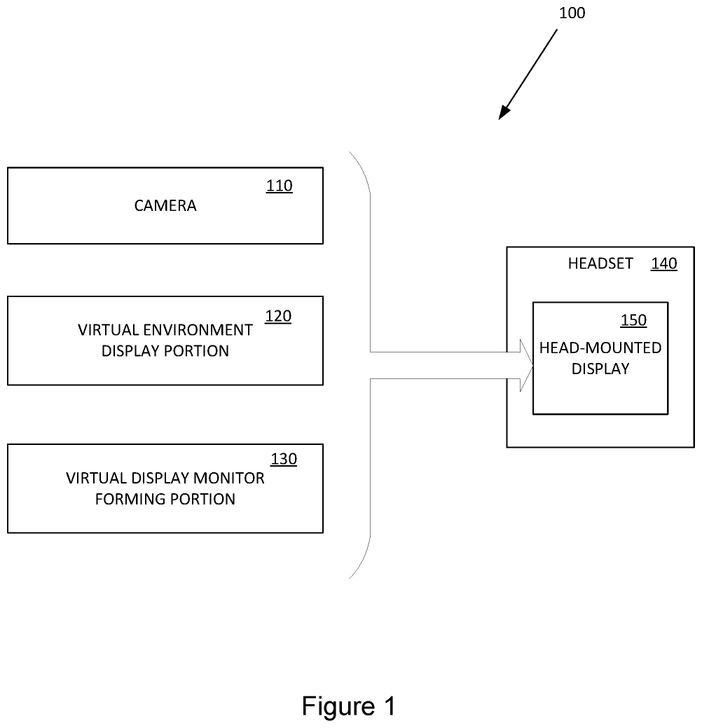

Referring now to FIG. 1, an example virtualization system 100 is illustrated. The example system 100 of FIG. 1 includes a camera 110, a virtual environment display portion 120, a virtual display monitor forming portion 130, and a headset 140. In various examples, the camera 110 may be a digital camera to capture a still image or provide a video stream. As described below, in some examples, the camera 110 may be provided as part of the headset 140. In other examples, the camera 110 may be provided in another physical position. In various examples, the camera is coupled to at least one of the virtual environment display portion 120, the virtual display monitor forming portion 130, or the headset 140, such as a VR headset. The virtual environment display portion 120 and the virtual display monitor forming portion 130 may composite images for display on a head-mounted display 150 of the headset 140. The virtual environment display portion 120 and/or the virtual display monitor forming portion 130 may be implemented as hardware, software, firmware or a combination thereof. In one example, at least one of the virtual environment display portion 120 or the virtual display monitor forming portion 130 are implemented in a processor attached to the head-mounted display 150 in the headset 140. In another example, each of the virtual environment display portion 120 and the virtual display monitor forming portion 130 may be external to the headset 140, for example, in a PC connected to the headset 140 via a cable or wirelessly.

In various examples, the head-mounted display 150 may include a screen or a screen portion for each eye. In one example, the head-mounted display 150 includes a screen that includes a left-eye portion and a right-eye portion corresponding to each eye of the user.

In various examples, the virtual environment display portion 120 is provided to generate a virtualized environment to be displayed on the head-mounted display 150. As used herein, virtualized environment includes virtual reality, as well as augmented reality in which a virtual environment and the physical environment are displayed together. In some examples of augmented reality systems, the user is provided with a direct view of the physical environment, and virtual elements are overlaid onto the physical environment via, for example, a half-silvered mirror. In this regard, virtual elements may augment the physical environment of the user.

In one example, the virtual environment display portion 120 generates two corresponding images, one for the left-eye portion of the head-mounted display 150 and another for the right-eye portion of the head-mounted display 150. As noted above, the virtual environment display portion 120 may be provided, in some examples, in the headset 140 (e.g., in a processor of the headset 140), and in other examples, external to the headset 140 (e.g., in a processor of a PC connected to the headset 140).

In various examples, the virtual display monitor forming portion 130 is provided to form a virtual display monitor in the virtualized environment generated by the virtual environment display portion 120. The virtual display monitor is generated in response to detection, or identification, of a physical tag by the camera 110. The physical tag may be associated with or include information used by the virtual display monitor forming portion 130 to form the virtual display monitor. For example, the information may include dimensions or resolution of the virtual display monitor. As described in greater detail below, the virtual display monitor formed by the virtual display monitor forming portion 130 may be a display monitor which can display a video output from, for example, a user device or computer system (e.g., desktop or laptop).

In various examples, the window formed by the window forming portion 130 corresponds to a physical location of the physical tag detected, captured or identified by the camera 110. The location of the virtual display monitor may be determined by any of a variety of manners, examples of which are described below. In one example, the location of the virtual display monitor in the VR environment corresponds to the physical location of the physical tag in the physical environment. Further, in various examples, the size of the virtual display monitor may be significantly larger than the size of the physical tag. In this regard, the location of the virtual display monitor may be indicated as centered or otherwise aligned with respect to the position of the physical tag.

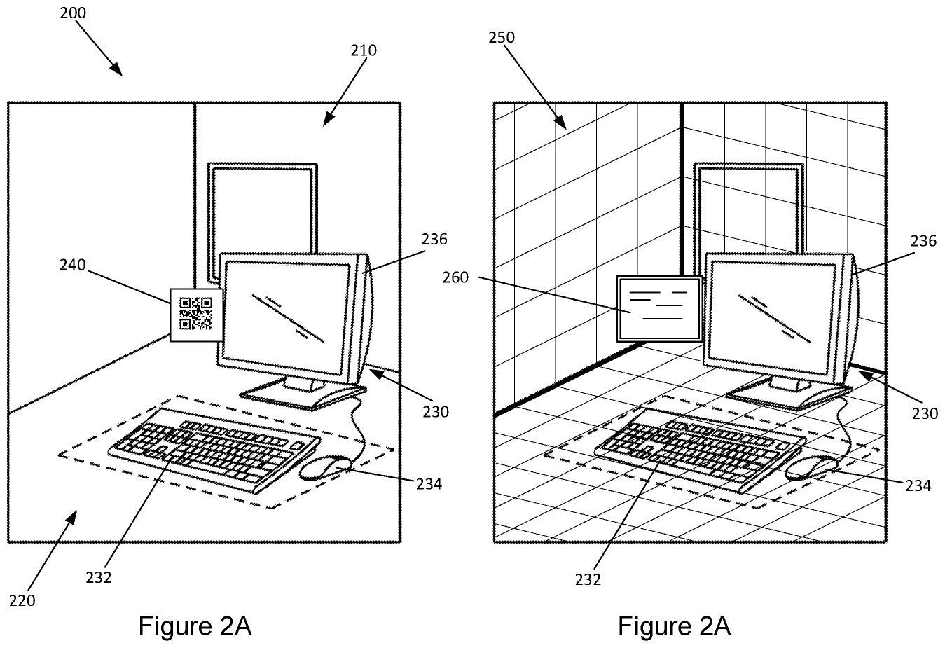

Referring now to FIGS. 2A and 2B, an example arrangement 200 is illustrated with an example physical environment 210 and a corresponding example virtualized environment 250. In the example arrangement 200, the example physical environment 210 of FIG. 2A is illustrated as a room 220, such as an office. Various objects are provided in the physical environment 210 that may be found in a workspace, such as a computer system 230. The computer system 230 includes various input devices, such as a keyboard 232 and a mouse 234. The computer system 230 further includes a display device, such as a physical display monitor 236.

The example physical environment 210 of FIG. 2A is provided with a physical tag 240. In various examples, the physical tag 240 may be an identifier, such as a two-dimensional bar code, a quick-read (QR) code or other such identifier. The physical tag 240 may be of any size that is detectable or readable by a camera or other detection mechanism.

Referring now to the example virtualized environment 250 of FIG. 2B, the example virtualized environment 250 may be generated and viewed in a virtualization system. In this regard, the example virtualized environment 250 may be generated for viewing using a head-mounted display, such as the head-mounted display 150 illustrated in FIG. 1. As noted above, the example virtualized environment 250 may be a virtual-reality (VR) environment or an augmented reality (AR) environment which includes virtual components combined with the example physical environment 210. In this regard, the example virtualized environment 250 includes the computer system 230, the keyboard 232, the mouse 234, and the physical display monitor 236.

As illustrated in FIG. 2B, a virtual display monitor 260 is formed in the virtualized environment 250. The virtual display monitor 260 is positioned in place of the physical tag 240 in the example physical environment 210. As further described below, the position of the virtual display monitor 260 in the example virtualized environment 250, as well as the size or other parameters of the virtual display monitor 260, may be determined by a processor, for example. In one example, the processor may be part of a virtualization system which includes the headset. In another example, the processor is part of the computer system 230.

In various examples, the processor uses the physical tag 240 to obtain information related to the virtual display monitor 260. For example, the physical tag 240 may direct the processor to a database including parameters of the virtual display monitor 260.

In the example virtualized environment 250, the virtual display monitor 260 may display content from a source. For example, the content may be an extension of content displayed on the physical monitor 236 of the computer system 230. In this regard, a user may print the physical tag 240 and place it in a desired position. This results in the formation of an additional monitor in the virtualized environment 250. Thus, the user is able to add a monitor without using valuable desk space and without the expense of a physical monitor.

The example of FIGS. 2A and 2B illustrates the physical tag being positioned in a stationary location adjacent to a physical monitor. In some examples, the physical tag may be positioned in any of a variety of locations. In one example, the physical tag is placed on a user's wrist and may appear as a monitor on a wrist watch. Further, while FIGS. 2A and 2B illustrate the virtual monitor being used to display content that is an extension of content on a physical monitor, in other examples, the virtual display monitor may be the primary or only monitor.

In some examples, the virtual display monitor is formed to mimic a touch screen. In this regard, the virtual display monitor may be responsive to gestures by the user, which can be detected using a camera, such as the camera 110 in the example system 100 described above with reference to FIG. 1. In this regard, the gestures may operate as virtual touching of the screen and may include, for example, pinching, swiping, pointing or other such gestures common to touch screens.

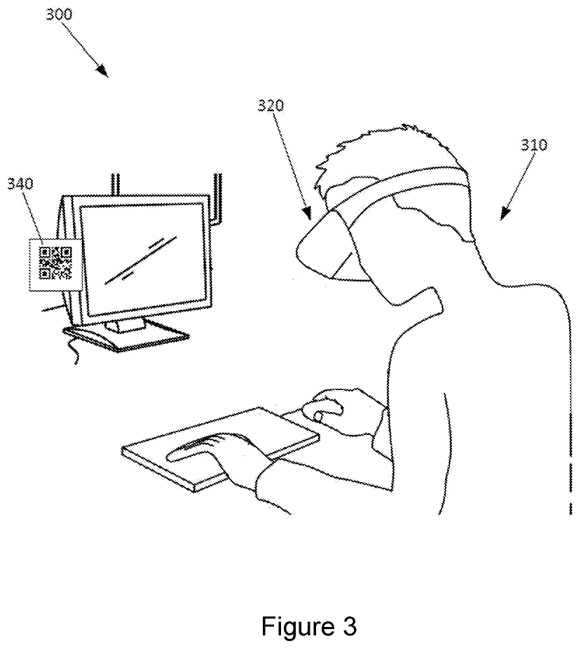

Referring now to FIG. 3, an example arrangement 300 with a user having a virtualization headset 320 is illustrated. In the example illustrated in FIG. 3, a user 310 uses a headset 320 while working in a physical environment, similar to the example physical environment 210 of FIG. 2A. The headset 320 allows the user to view a virtualized environment, similar to the example virtualized environment 250 of FIG. 2B. In this regard, the physical environment includes a physical tag 340, which results in the formation of a virtual display monitor in the virtual environment presented to the user 310 through the headset 320.

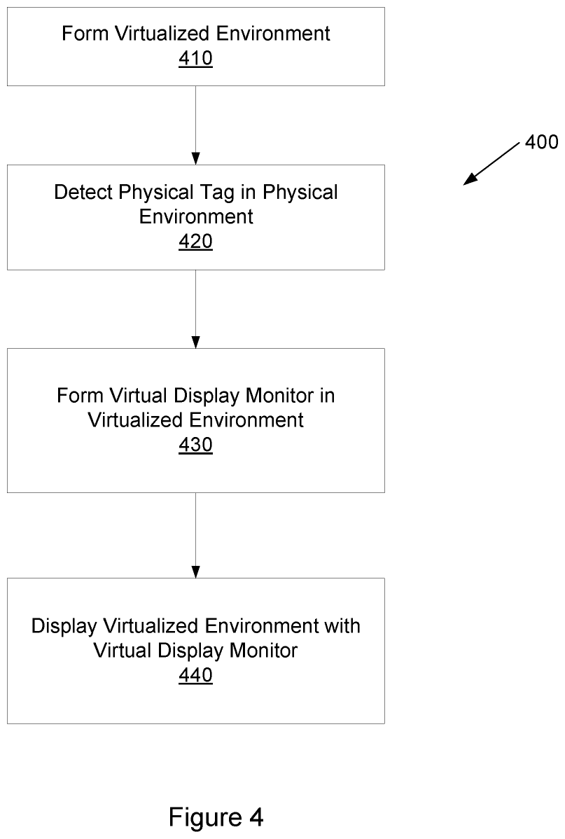

Referring now to FIG. 4, a flow chart illustrates an example method 400 for forming a virtual display monitor in a virtualized environment. The example method 400 of FIG. 4 includes forming a virtualized environment (block 410). As noted above, the forming of the virtualized environment may be performed by a processor in the headset or in another processor separate from the headset. In the example of FIG. 1 above, the virtualized environment may be formed for display by the virtual environment display portion 120 of the example system 100.

The example method 400 further includes detection, or identifying, of a physical tag in the physical environment (block 420). As noted above, the physical tag may be detected by the camera 110 of the example system 100 of FIG. 1.

The example method 400 of FIG. 4 further includes forming a virtual display monitor in the virtualized environment (block 430). In various examples, the location of the virtual display monitor in the virtualized environment corresponds to the location of the physical tag in the physical environment. As illustrated in the example of FIGS. 2A and 2B, the virtual display monitor 260 in the virtualized environment replaces or overlays the physical tag 240.

The example method 400 further includes displaying the virtualized environment and the virtual display monitor (block 440). In various examples, the virtualized environment and the virtual display monitor are displayed to a user in a headset having a head-mounted display, as illustrated in the example of FIG. 1.

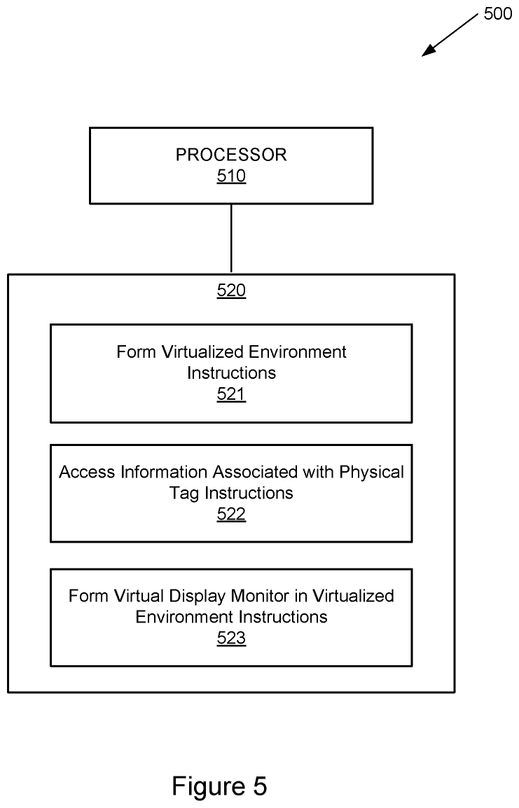

Referring now to FIG. 5, a block diagram of an example system is illustrated with a computer-readable storage medium including instructions executable by a processor for forming a virtual display monitor. The system 500 includes a processor 510 and a non-transitory computer-readable storage medium 520. The computer-readable storage medium 520 includes example instructions 521-523 executable by the processor 510 to perform various functionalities described herein. In various examples, the non-transitory computer-readable storage medium 520 may be any of a variety of storage devices including, but not limited to, a random access memory (RAM) a dynamic RAM (DRAM), static RAM (SRAM), flash memory, read-only memory (ROM), programmable ROM (PROM), electrically erasable PROM (EEPROM), or the like. In various examples, the processor 510 may be a general purpose processor, special purpose logic, or the like.

The example instructions include form virtualized environment instructions 521. In various examples, a virtualized environment may be formed which includes physical and/or virtual components.

The example instructions further include access information associated with a physical tag instructions 522. As noted above, a physical tag in the physical environment may be detected or identified using a camera. The physical tag may be an identifier, such as a two-dimensional bar code or a QR code. The physical tag may direct the processor 510 to a database which includes information related to the physical tag. The information may include parameters associated with a virtual display monitor, such as dimensions, resolution, and/or content source, for example.

The example instructions further include forming a virtual display monitor in the virtualized environment instructions 523. The virtual display monitor is formed based on the information associated with the physical tag. As illustrated in FIGS. 2A and 2B, the location of the virtual display monitor in the virtualized environment is associated with the physical location of the physical tag in the physical environment.

Thus, in various examples, a user may form additional monitors in the virtual environment without the need to use additional work space. Further, cost of additional monitors is eliminated, and installation of physical monitors can be avoided.

Software implementations of various examples can be accomplished with standard programming techniques with rule-based logic and other logic to accomplish various database searching steps or processes, correlation steps or processes, comparison steps or processes and decision steps or processes.

The foregoing description of various examples has been presented for purposes of illustration and description. The foregoing description is not intended to be exhaustive or limiting to the examples disclosed, and modifications and variations are possible in light of the above teachings or may be acquired from practice of various examples. The examples discussed herein were chosen and described in order to explain the principles and the nature of various examples of the present disclosure and its practical application to enable one skilled in the art to utilize the present disclosure in various examples and with various modifications as are suited to the particular use contemplated. The features of the examples described herein may be combined in all possible combinations of methods, apparatus, modules, systems, and computer program products.

It is also noted herein that while the above describes examples, these descriptions should not be viewed in a limiting sense. Rather, there are several variations and modifications which may be made without departing from the scope as defined in the appended claims.

What is claimed is:

1. A system, comprising:
a camera to capture an image of a physical tag;
a virtual environment display portion to generate a virtualized environment;
a virtual display monitor forming portion to create a virtual display monitor in the virtualized environment, a position of the virtual display monitor in the virtualized environment corresponding to a physical location of the physical tag, at least one parameter of the virtual display monitor being associated with the physical tag; and
a headset including a head-mounted display to display the virtualized environment, the virtualized environment including the virtual display monitor.

2. The system of claim 1, wherein the physical tag is associated with a content source to be displayed on the virtual display monitor.

3. The system of claim 1, wherein the camera is mounted in the headset.

4. The system of claim 1, wherein at least one of the virtual environment display portion or the virtual display monitor forming portion is provided within the headset including the head-mounted display.

5. The system of claim 1, wherein the virtual display monitor is to display an extension of a physical monitor.

6. A method, comprising:
forming, by a processor in a virtualization headset, a virtualized environment;
detecting a physical tag in a physical environment;
forming a virtual display monitor in the virtualized environment, a location of the virtual display monitor in the virtualized environment corresponding to a physical location of the physical tag; and
displaying the virtualized environment with the virtual display monitor on a head-mounted display.

7. The method of claim 6, further comprising:
displaying content on the virtual display monitor in the virtualized environment, a source of the content being indicated by the physical tag.

8. The method of claim 7, wherein the content displayed on the virtual display monitor is an extension of content displayed on a physical monitor.

9. The method of claim 6, wherein the virtual display monitor is responsive to gestures by a user.

10. The method of claim 6, wherein detecting the physical tag in the physical environment includes:
capturing an image of the physical tag; and
accessing information associated with the physical tag, the information being indicative of parameters of the virtual display monitor.

11. A non-transitory computer-readable storage medium encoded with instructions executable by a processor of a computing system, the computer-readable storage medium comprising instructions to:
form a virtualized environment;
access information associated with a physical tag in a physical environment; and
form a virtual display monitor in the virtualized environment, a location of the virtual display monitor in the virtualized environment being associated with a location of the physical tag in the physical environment, the information associated with the physical tag being indicative of parameters of the virtual display monitor.

12. The non-transitory computer-readable storage medium of claim 11, wherein the parameters of the virtual display monitor including at least one of dimensions or resolution of the virtual display monitor.

13. The non-transitory computer-readable storage medium of claim 11, wherein parameters of the virtual display monitor include source of content to be displayed on the virtual display monitor.

14. The non-transitory computer-readable storage medium of claim 13, wherein the content is an extension of content displayed on a physical monitor.

15. The non-transitory computer-readable storage medium of claim 11, wherein the virtual display monitor is responsive to gestures by a user.
